(19) United States
(12) Patent Application Publication
(10) Pub. No.: US 2008/0256836 A1
(43) Pub. Date: Oct. 23, 2008

(54) Slip Over Decorative Frame

(76) Inventor: Jeffrey Scott Lincoln, Cherry Hill, NJ (US)

Correspondence Address: PATWRITE LLC, 408 W. MAIN ST., MARSHALLTOWN, IA, 50158-5759, US

(21) Appl. No.: 12/106,593

(22) Filed: Apr. 21, 2008

Related U.S. Application Data
(60) Provisional application No. 60/913,189, filed on Apr. 20, 2007.
(60) Provisional application No. 60/914,077, filed on Apr. 26, 2007.

(51) Int. Cl. G09F 15/00

(52) U.S. Cl. 40/606.09; 40/606.01; 40/606.16; 40/607.01

(57) ABSTRACT

A decorative slip over frame comprises a first and second upright post each having at least one adjustment slot running substantially along opposing facing sides. An upper horizontal support has an insertion slider on each end that moveably slides in the adjustment slot. At least one lower horizontal support also has an insertion slider on each end. The upper horizontal and lower horizontal supports move independently to provide adjustability when concealing a sign frame or edge. In one embodiment, two lower horizontal supports are used where each lower support is independently adjustable. In one embodiment, a decorative final tops each upright post and has a slot to accept additional signage. In one embodiment, the slip over decorative frame slips over the top of a metal frame sign. In another embodiment, the sign slides in from the top, side or is sandwiched or hinged between the frames.

### RELATED APPLICATIONS

This application claims priority to Provisional Application Ser. Nos. 60/914,077 filed on Apr. 26, 2007 and 60/913,189, filed on Apr. 20, 2007, the complete disclosures of each of which are hereby incorporated by reference.

### BACKGROUND OF THE INVENTION

The history of signage is as old and varied as the history of humankind itself. From primitive cave paintings to Egyptian stone obelisks used to record laws and treaties, signs have been used to convey messages. Along with informational signage, advertising was important even in the ancient world where ruins in Pompeii show merchants with wares for sale. We are used to seeing advertising signs in modern life and we can scarcely imagine life without them.

Signs come in many sizes and types with some being permanent and others temporary in nature such as garage sale or political signs. One area that has made extensive use of temporary signs is the real estate business. We are all used to seeing “for sale” signs advertising houses and land. The ubiquitous metal frame sign has been a staple of the Real Estate business for many years. While the metal frame sign does advertise that the property is for sale, it is not very attractive. There is a need for an easy to setup and use frame that fits over signs to provide an attractive image.

### SUMMARY OF THE INVENTION

A decorative slip over frame comprises a first and second upright post each having at least one adjustment slot running substantially along opposing facing sides. An upper horizontal support has an insertion slider on each end that moveably slides in the adjustment slot. At least one lower horizontal support also has an insertion slider on each end. The upper horizontal and lower horizontal supports move independently to provide adjustability when concealing a sign frame or sign edge. In one embodiment, two lower horizontal supports are used where each lower support is independently adjustable. In one embodiment, a decorative finial tops each upright post and has a slot to accept additional signage. In one embodiment, the slip over decorative frame slips over the top of a metal sign frame. In another embodiment, the sign slides in from the top, side or is sandwich or hinged between the frames.

Other features and advantages of the instant invention will become apparent from the following description of the invention which refers to the accompanying drawings.

### BRIEF DESCRIPTION OF THE DRAWINGS

FIG. 1 is a front view of a slip over decorative frame according to an embodiment of the present invention.

FIG. 2 is a front view of a slip over decorative frame in a typical use according to an embodiment of the present invention.

FIG. 3 is a side view of the slip over decorative frame shown in FIG. 2.

FIG. 4 is a perspective view of a slip over decorative frame according to an embodiment of the present invention.

FIG. 5 is a perspective view of a slip over decorative frame according to an embodiment of the present invention.

FIG. 6 is a perspective view of the slip over decorative frame shown in FIG. 1.

FIG. 7 is a detailed view of the section shown in FIG. 6.

FIG. 8 is a perspective view of the slip over decorative frame shown in FIG. 1.

FIG. 9 is a perspective view of a slip over decorative frame according to an embodiment of the present invention.

FIG. 10 is a detailed view of the section shown in FIG. 9.

FIG. 11 is a perspective view of a slip over decorative frame according to an embodiment of the present invention.

FIG. 12 is a perspective view of the slip over decorative frame shown in FIG. 9 according to an embodiment of the present invention.

FIG. 13 is a perspective view of a slip over decorative frame according to an embodiment of the present invention.

FIG. 14 is a perspective view of a slip over decorative frame according to an embodiment of the present invention.

FIG. 15 is a perspective drawing of a slip over decorative frame in a typical application according to an embodiment of the present invention.

FIG. 16 is a perspective drawing of the slip over decorative frame in a typical application shown in FIG. 15 according to an embodiment of the present invention.

FIG. 17 is a perspective view of a slip over frame according to an embodiment of the present invention.

FIG. 18 is a detail view of the section shown in FIG. 17.

FIG. 19 is a side view of the slip over decorative frame shown in FIG. 17.

FIG. 20 is a side view of the horizontal support of FIG. 17.

FIG. 21 is an end view of the horizontal support of FIG. 17.

FIG. 22 is a top view of the horizontal support of FIG. 17.

FIG. 23 is a perspective view of a typical assembly of a slip over decorative frame according to an embodiment of the present invention.

FIG. 24 is a perspective view of a typical assembly of a slip over decorative frame according to an embodiment of the present invention.

FIG. 25 is a side view of a typical use of a slip over decorative frame according to an embodiment of the present invention.

FIG. 26 is a side view of a slip over decorative frame according to an embodiment of the present invention.

FIG. 27 is a profile view of an upright post according to an embodiment of the present invention.

FIG. 28 is a profile view of an upright post according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

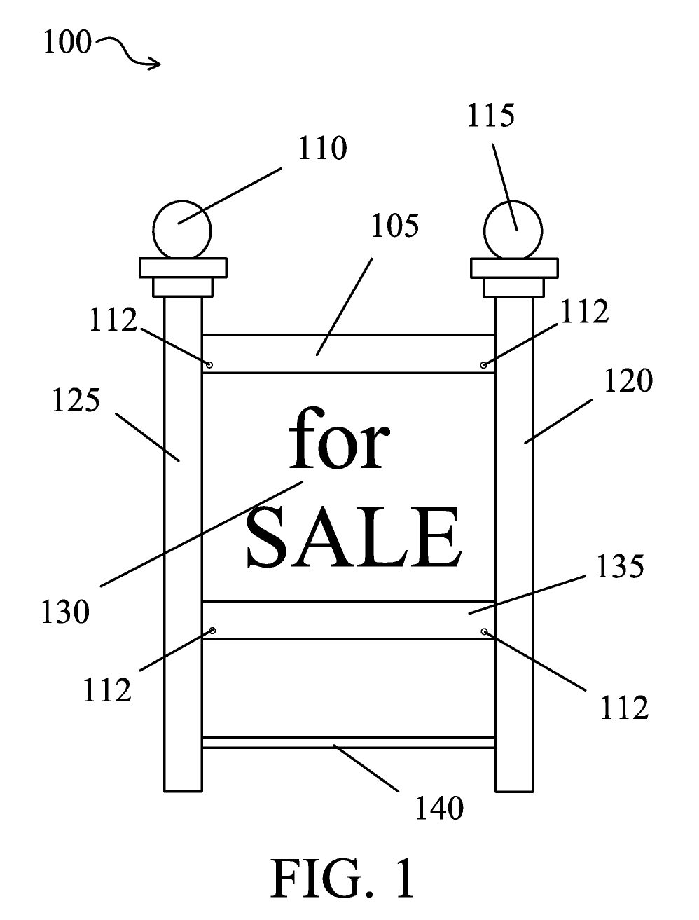

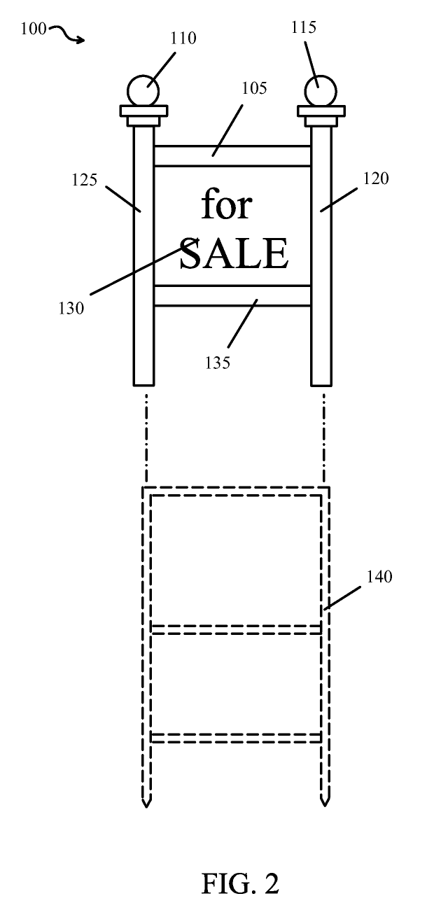

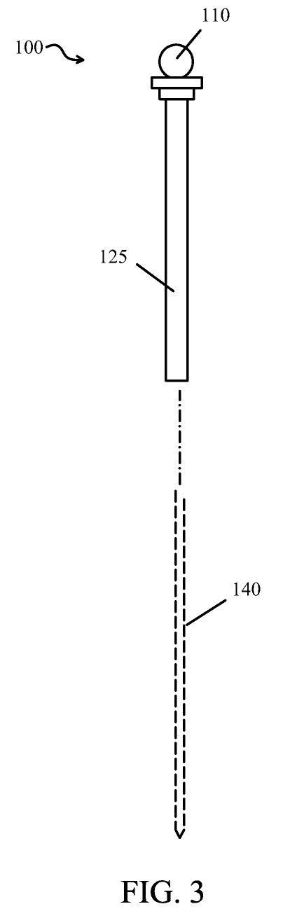

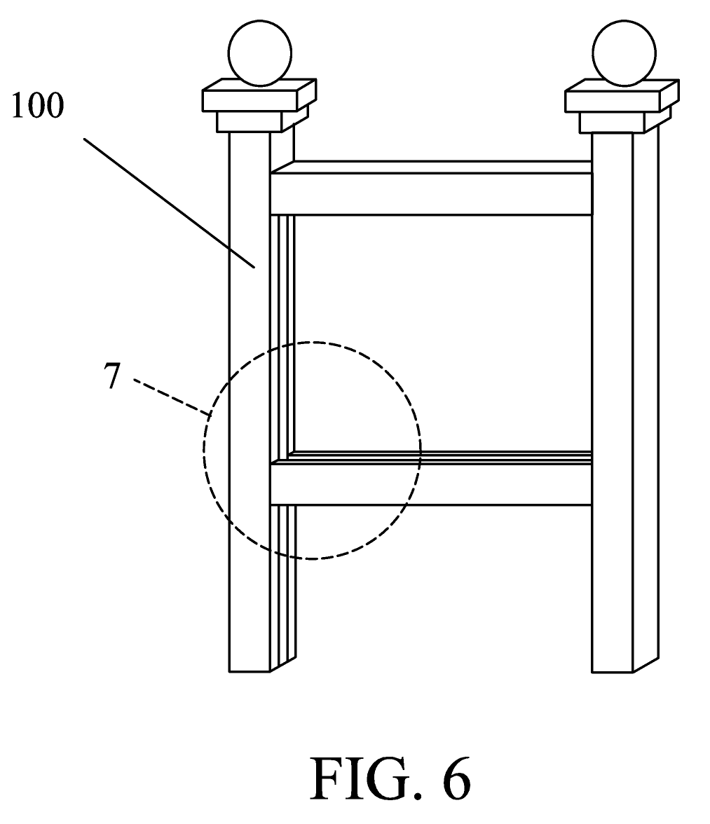

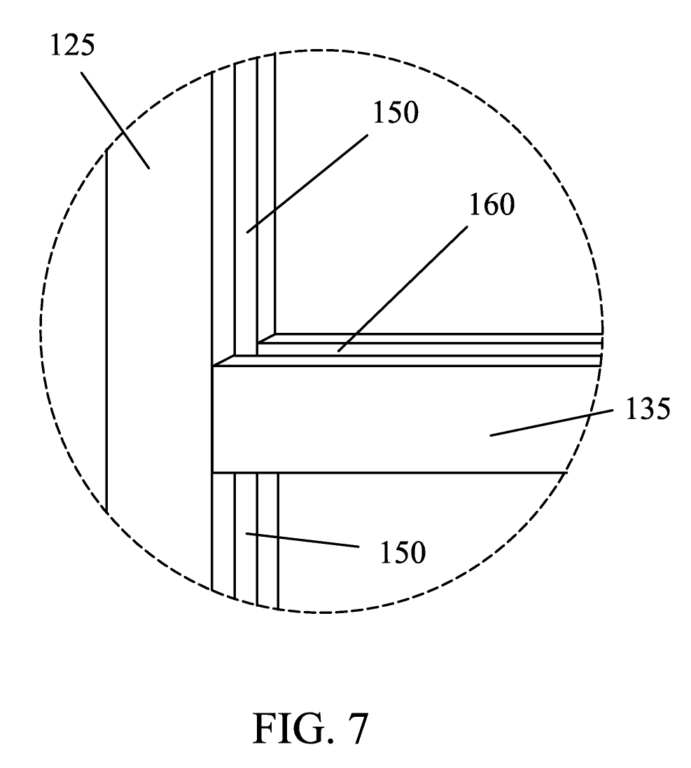

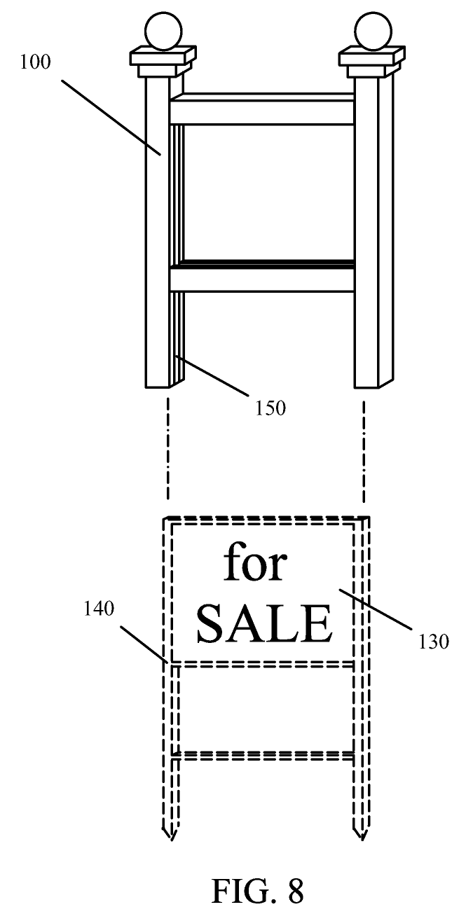

Referring to FIGS. 1-3 and 6-8, a slip over decorative frame 100 comprises a first vertical post 125 and a second vertical post 120. A decorative finial 110 and 115 is added to enhance the aesthetic and overall look of frame 100. An upper horizontal support 105 fits between first and second upright posts 125 and 120 respectively. A lower horizontal support 135 fits between first and second upright posts 125 and 120. Frame 100 slips over the top of a sign frame 140 to enhance and beautify a sign 130. Security holes 112 are provided in horizontal support 135 to secure sign 130 to frame 100. Nylon ties (not shown) or cable locks (not shown) or other similar locking device may be used to secure sign 130 within frame 100. A central slot 150 and horizontal slot 160 is provided to allow sign 130 and frame 140 to fit within frame 100.

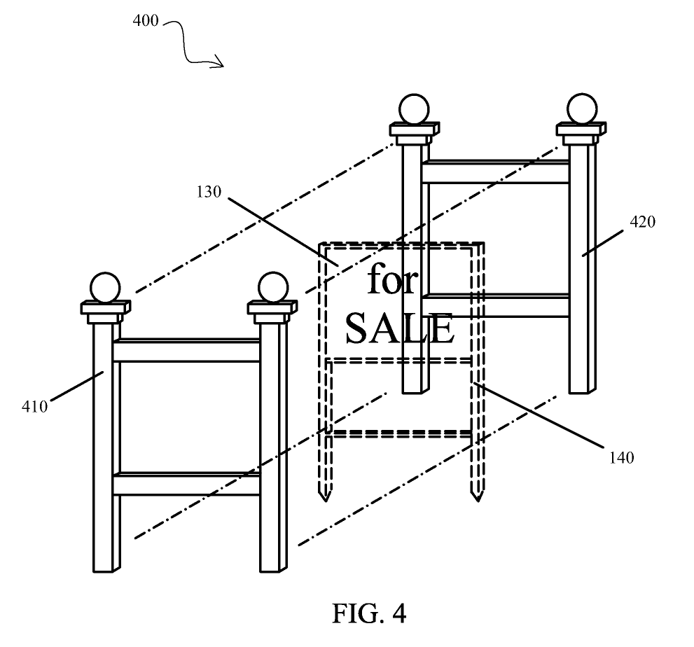

Referring now to FIG. 4, a slip over decorative frame 400 comprises a front frame 410 and a rear frame 420. A slot (not shown) is provided to fit sign 130 and sign frame 140 within front frame 410 and rear frame 420. A catch means (not shown) such as snaps or cam closure as is known in the art is provided to securely sandwich sign 130 and sign frame 140 therein. Of course other catch methods such as hook and loop fasteners are suitable as long as the two frames 410 and 420 are securely held in place.

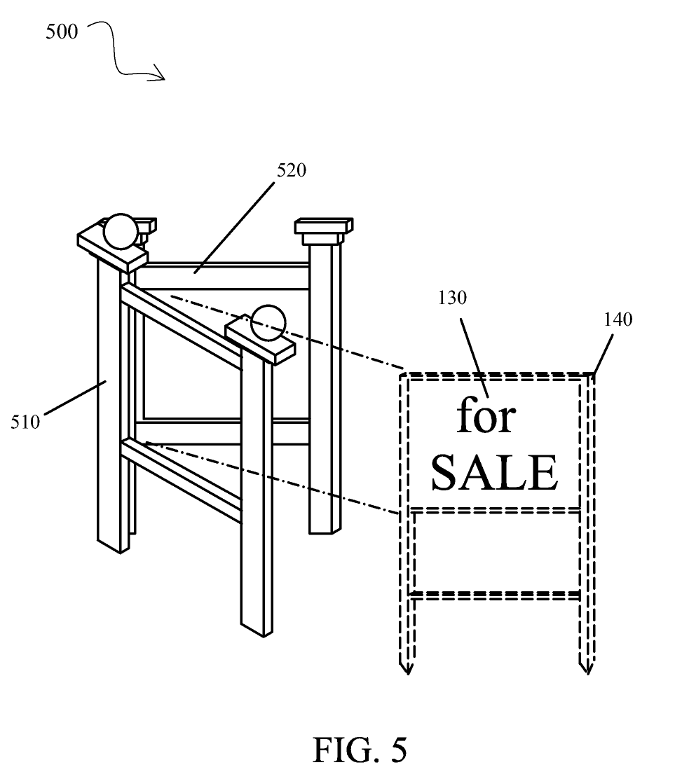

Referring now to FIG. 5, a slip over decorative frame 500 comprises a front frame 510 and a rear frame 520. A slot (not shown) is provided to fit sign 130 and sign frame 140 within front frame 510 and rear frame 520. Front frame 510 is hingedly attached to rear frame 520 so that sign 130 and/or sign frame 140 is sandwiched therein. A catch means (not shown) like snaps or cam closure as is known in the art is provided to secure sign 130 and sign frame 140 therein.

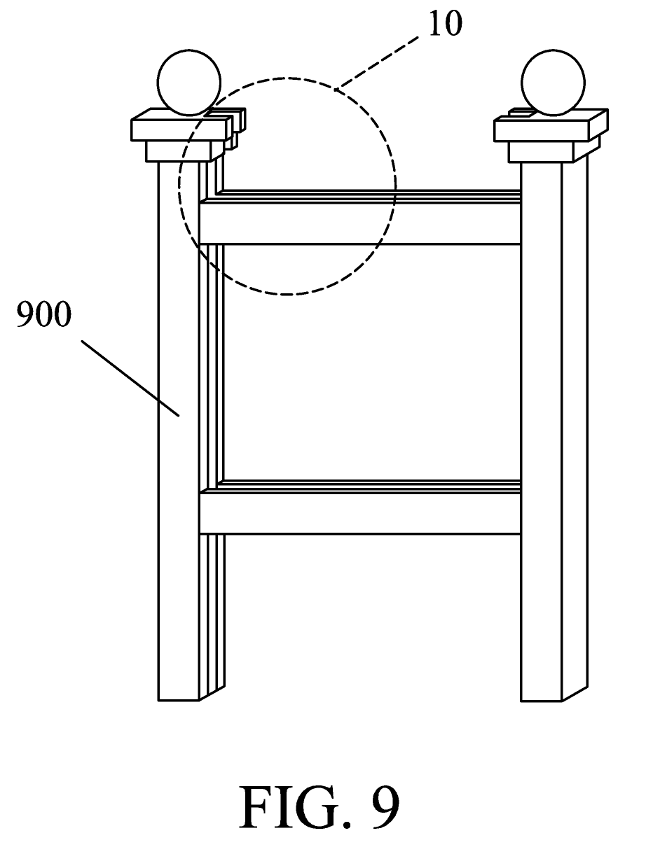

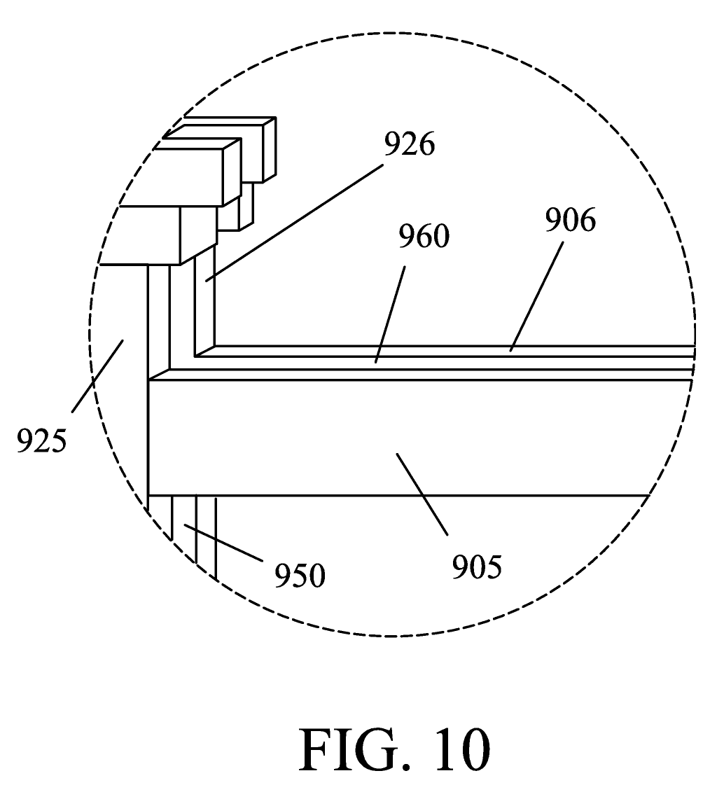

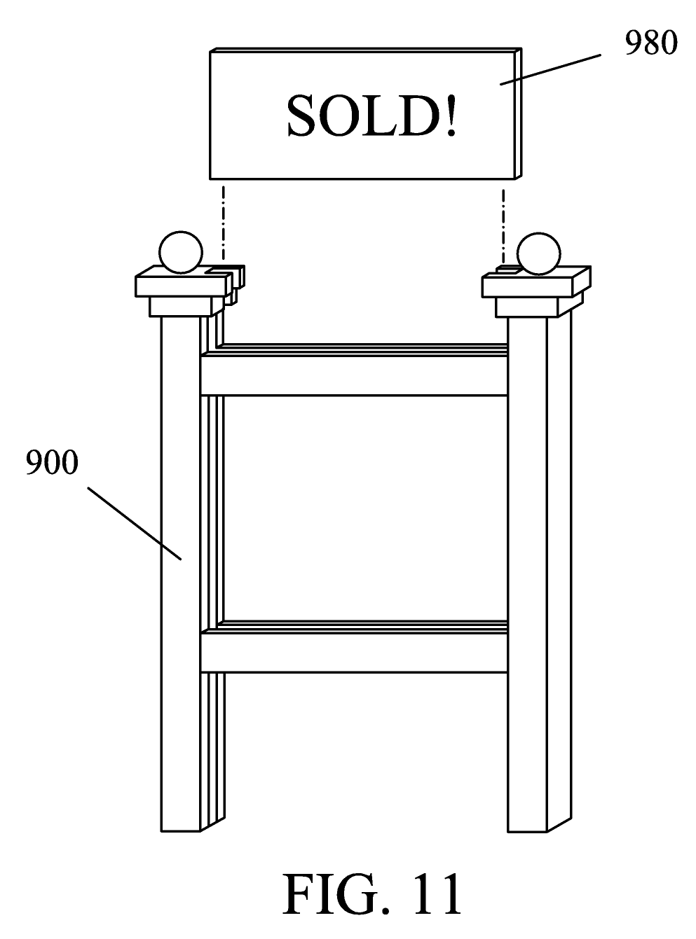

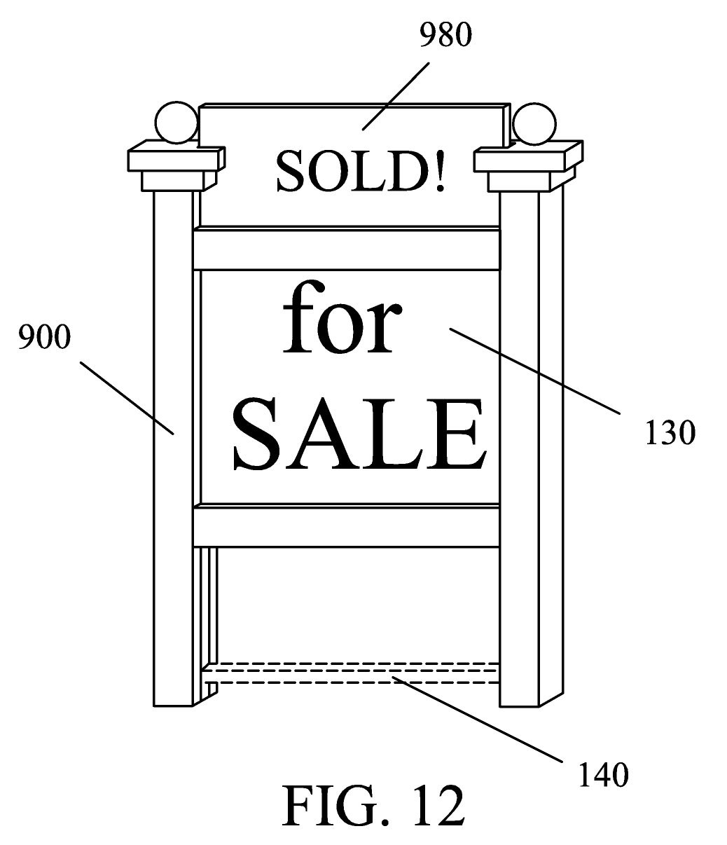

Referring now to FIGS. 9-12, a slip over decorative frame 900 is shown having a front vertical portion 925 and a rear vertical portion 926 with a central slot 950 disposed therein. Central slot 950 is used to slip over and conceal frame 140. A front horizontal support 905 and a rear horizontal support 906 have a slot 960 disposed therein. In use, the horizontal support may be one piece with two sides or two separate pieces. Slot 960 is formed in an upper portion of the horizontal support. Slot 960 is used to hold a top sign 980. As an alternative, two separate upper horizontal supports (not shown) may be used which will naturally form a slot between them. Top sign 980 rests within slot 960 to securely hold it therein. Of course, if two upper horizontal supports (not shown) are used, top sign 980 would be positioned on top of sign 130 or by using a sign separator (not shown).

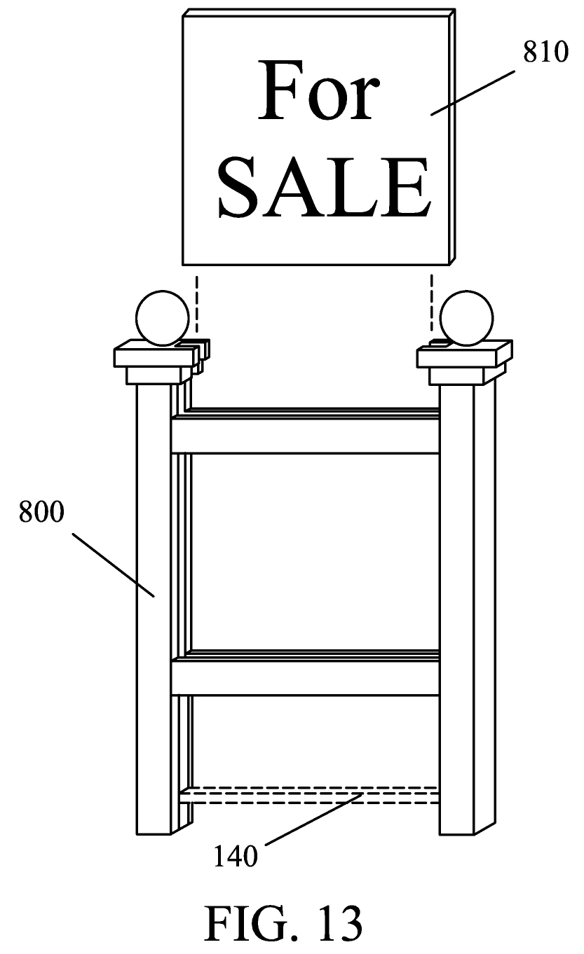

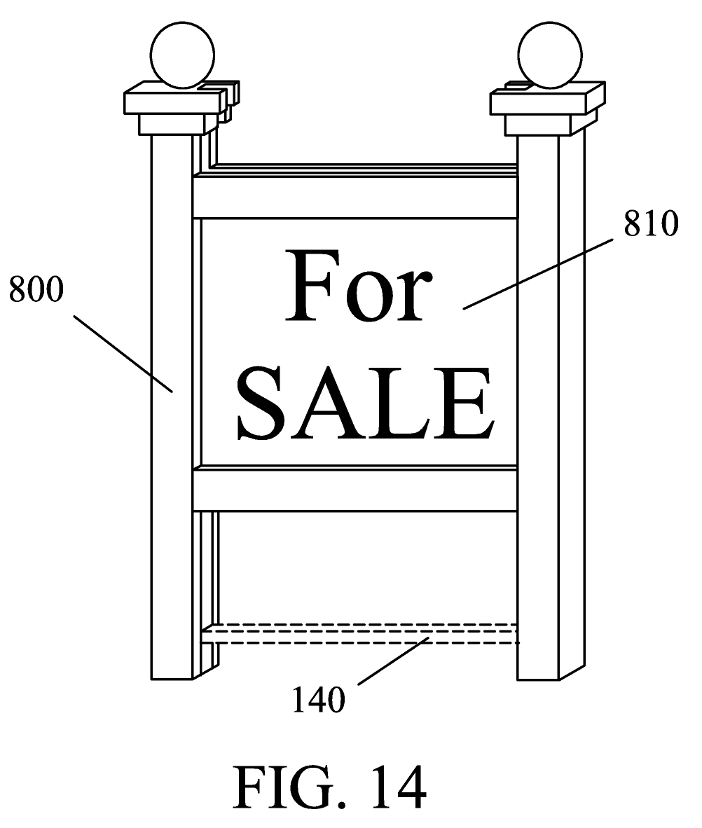

Now referring to FIGS. 13 and 14, a slip over decorative frame 800 is used to hold a drop in sign 810 which is slid in from the top and fits within a slot provided therein. Metal frame 140 fits within frame 800 and drop in sign 810 slides in place.

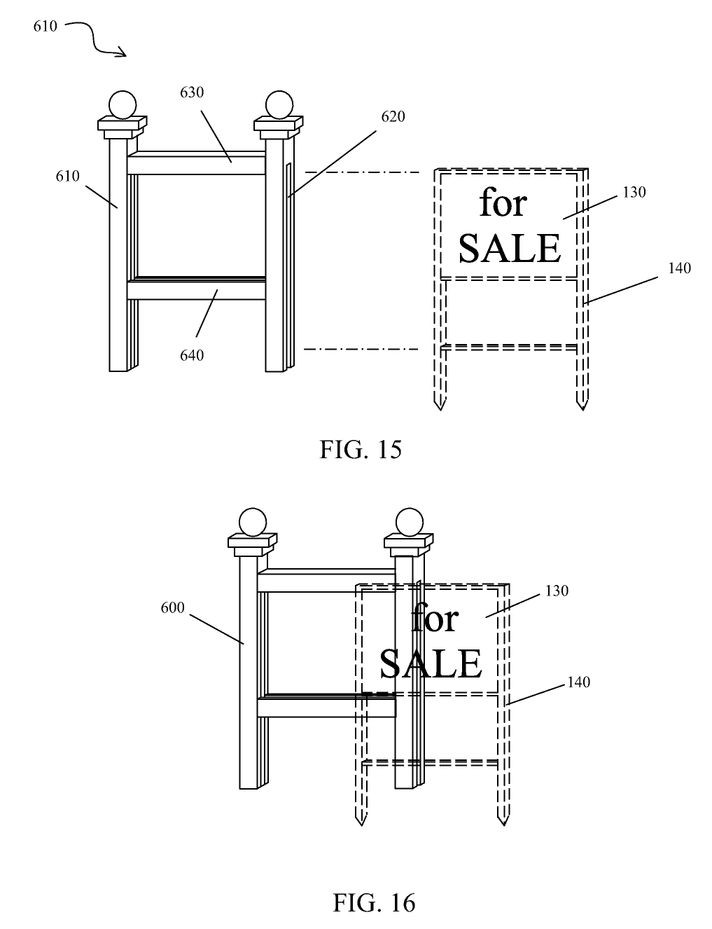

FIG. 15 and 16 illustrate an embodiment where frame 140 and sign 130 slide in from the side of frame 600. A first vertical post 610 and a second vertical post 620 hold an upper horizontal support 630 and a lower horizontal support 640 to secure sign 130 and/or sign frame 140. Sign frame 140 and sign 130 slides through slot 620 on frame 600 on the side to enhance the look of sign 130.

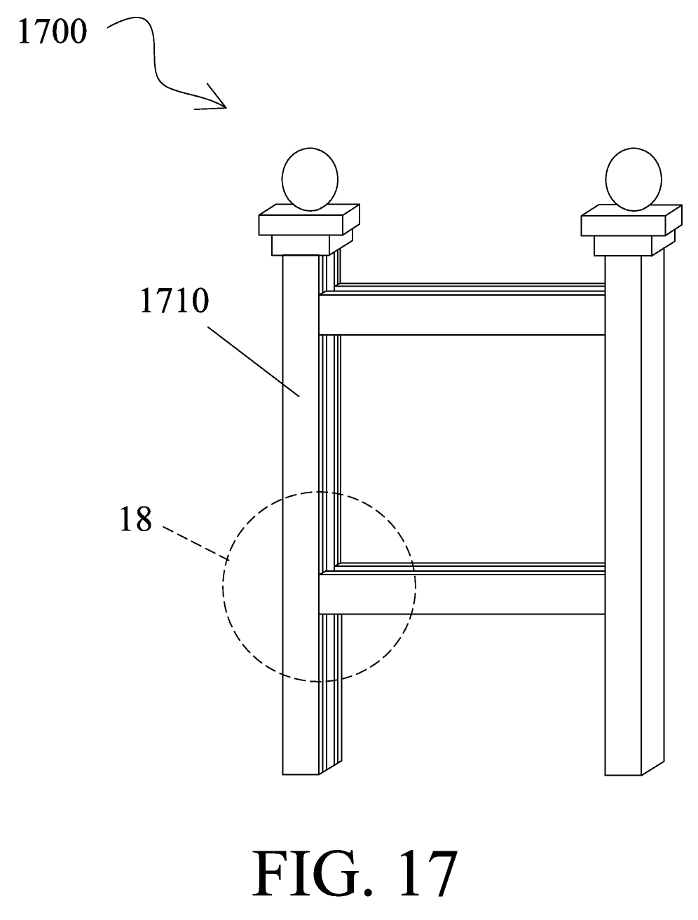

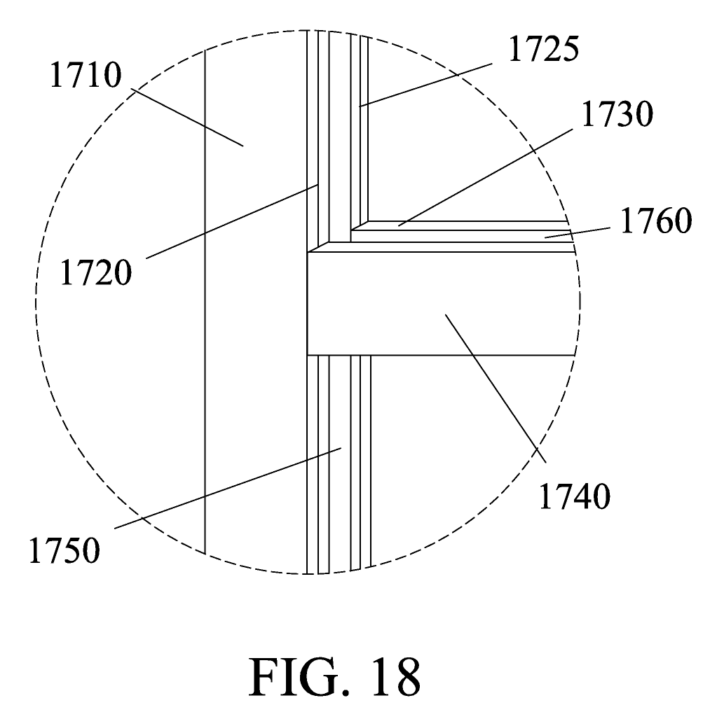

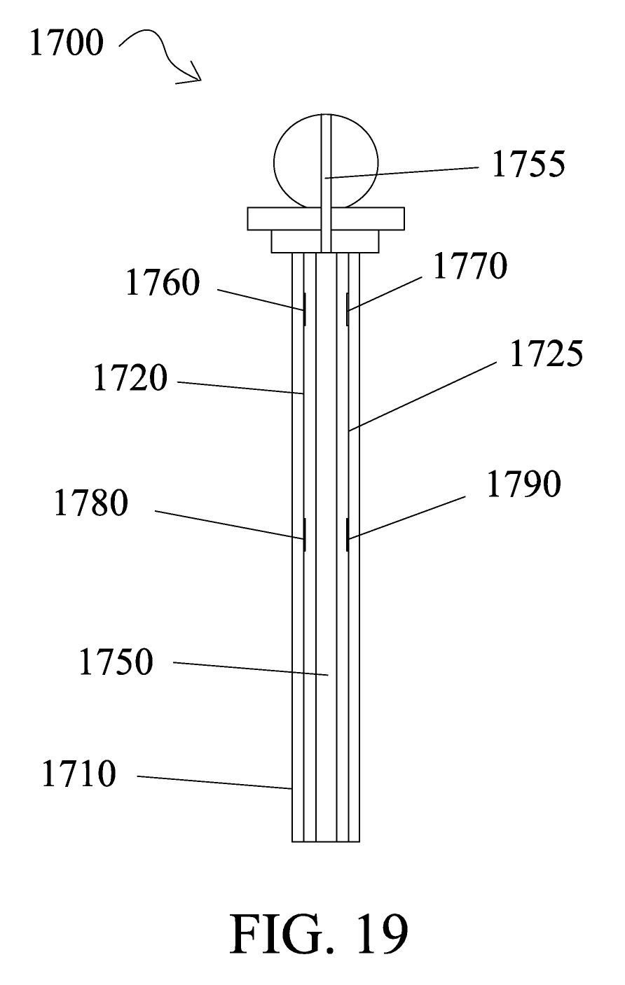

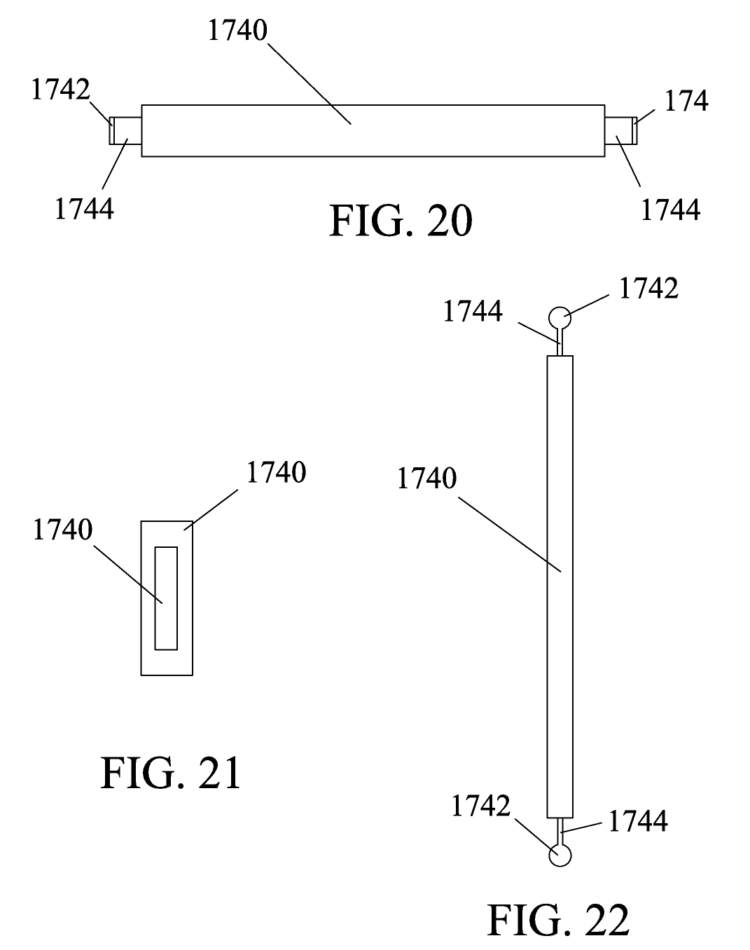

Now referring to FIGS. 17-22, a slip over decorative frame 1700 is shown having a vertical post 1710 with a front support adjustment slot 1720 and a rear support adjustment slot 1725. These slots 1720 and 1725 respectively, allow a front horizontal support 1740 and a rear horizontal support 1730 to move up and down selectively to provide a custom fit for a sign (not shown). Again, as discussed above the horizontal support may be a single piece with two sides or may be two individual supports. A central slot 1750 is provided to allow a sign (not shown) and/or a sign frame (not shown) to fit therein as well as a horizontal slot 1760. Horizontal slot 1760 is formed as a gap between front horizontal support 1740 and rear horizontal support 1730. The frame 1700 slips on over the top of the sign and sign frame to securely hold frame 1700 therein. A decorative finial 1745 is provided to enhance the overall look of frame 1700. A finial slot 1755 is provided to allow a top sign (not shown) to be placed therein. A plurality of insertion slots 1760,1770,1780 and 1790 are provided to allow an insertion slider 1744 with a slider restraint 1742 into support adjustment slots 1720 and 1725 respectively. Only the left side of frame 1700 is shown, but it is understood that the right side mirrors the detail shown therein. Additionally, a plurality of top signs (not shown) may be used to allow a user to customize the message such as phone numbers, price reduced, etc. as long as the signs are secured within finial slot 1755. A sign separator (not shown) may be used between the top and bottom of each additional sign to further secure them therein. A sign separator may be an H-channel allowing the bottom of a top sign to fit while the H-channel fits over the top of the sign below temporarily joining them together. Of course other configurations may be used as is known in the art.

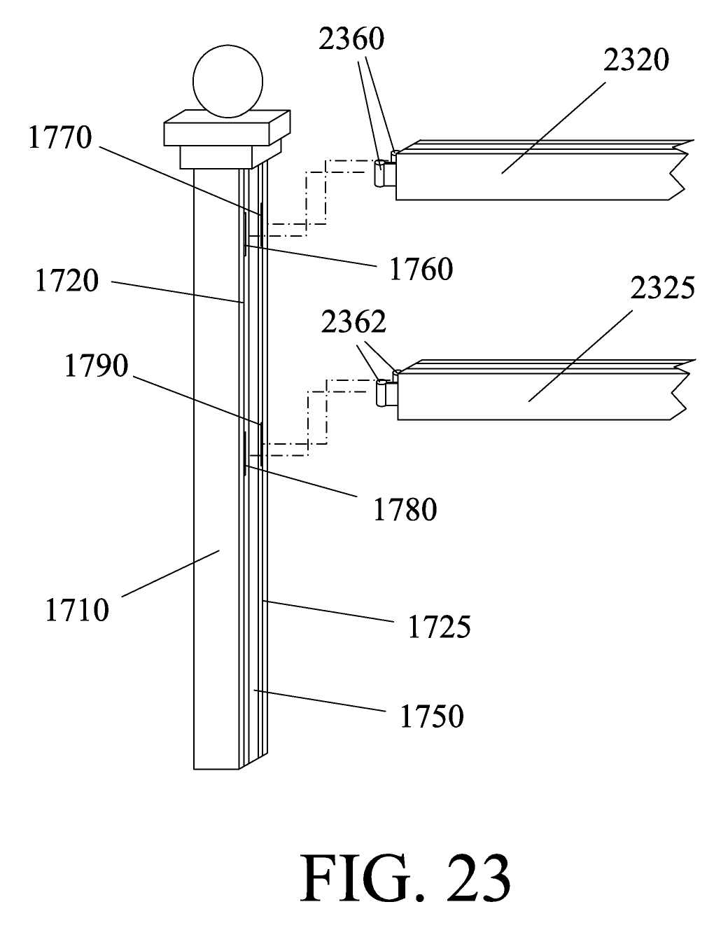

FIG. 23 illustrates a portion of a of a slip over decorative frame showing an embodiment using upright post 1710 that has a longitudinally disposed front adjustment slot 1720 and a rear adjustment slot 1725. In the embodiment shown, an upper horizontal support 2320 and a lower horizontal support 2325 is shown having two support sliders at each end that slip into upper insertion slots 1760 and 1770 and lower insertion slots 1780 and 1790 respectively. This allows upper horizontal support 2320 and lower horizontal support 2325 to be positioned along adjustment slots 1720 and 1725 independently providing a custom fit.

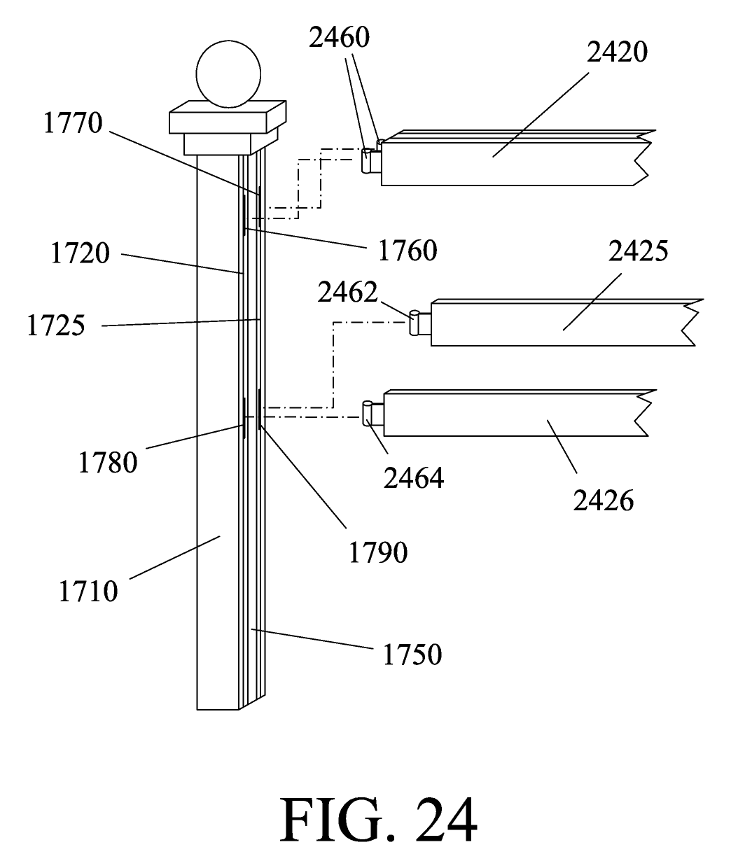

FIG. 24 illustrates an embodiment of the present invention that utilizes two lower horizontal supports 2426 and 2425 which are independently adjustable. Upright post 1710 is shown having two adjustment slots 1720 and 1725 longitudinally disposed therein. A plurality of insertion slots 1760,1770,1780 and 1790 are provided to allow support sliders 2460, 2462 and 2464 to be inserted as discussed above. The horizontal supports may also be removed by lining the sliders up with the insertion slots.

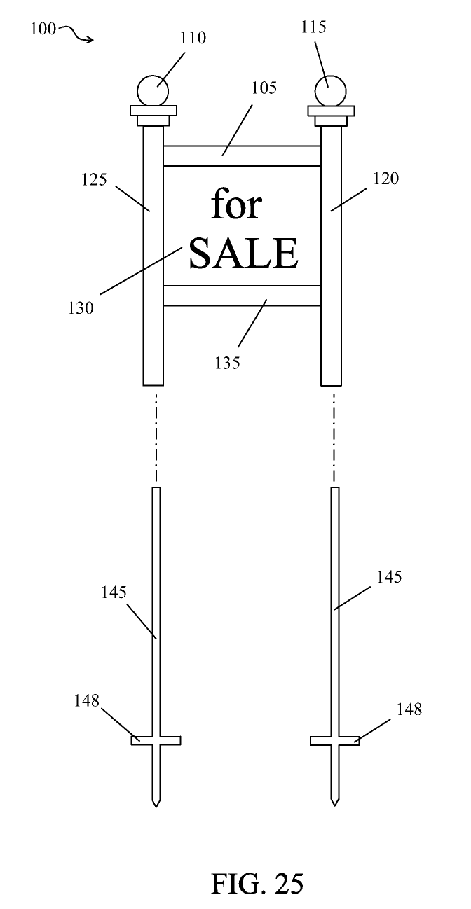

Now referring to FIGS. 25, 27-28, a pair of t-stakes 145 are provided for use when a sign frame (not shown) is not used or when added support is desired. T-stake 145 has a horizontal cross piece 148 to allow a user to push t-stake 145 into the ground. The upper end of t-stake 145 fit within a hollow portion 1752 of upright posts 125 and 120.

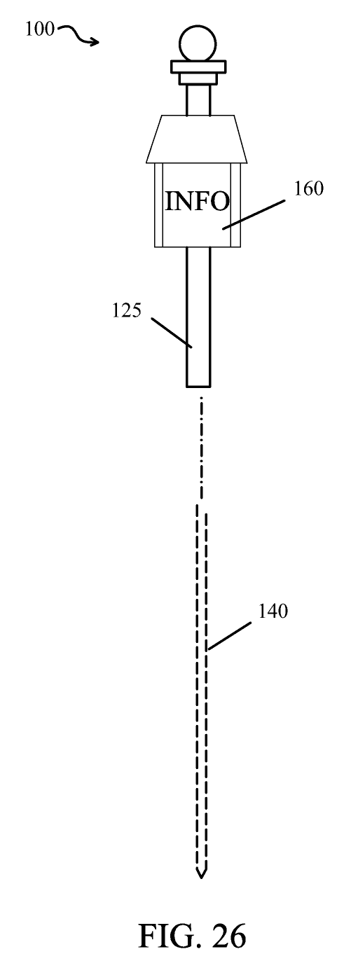

Referring to FIG. 26, an accessory 160 is attached to an upright post 125 or 120 to provide additional functionality. Other accessories include flag holders, clips, lights, etc.

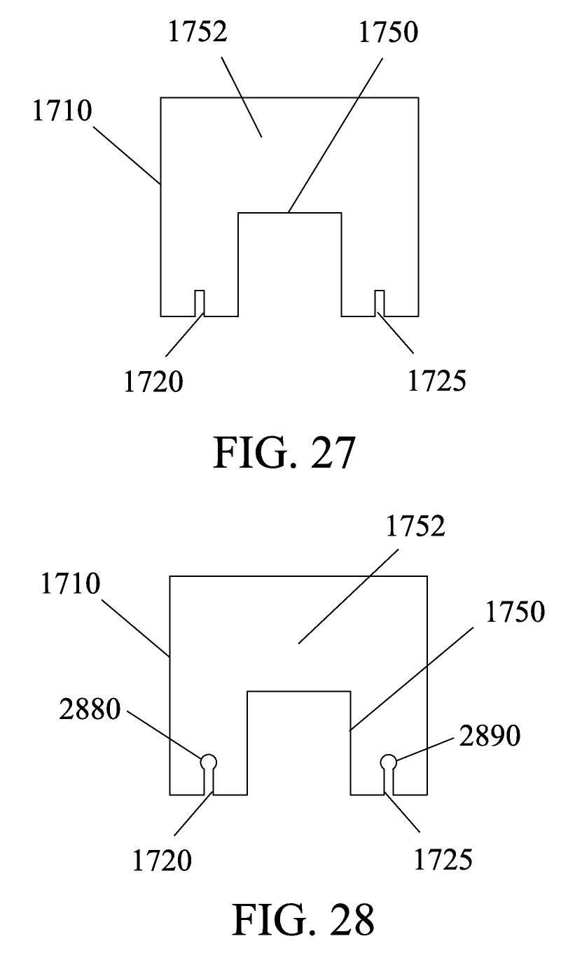

Referring again to FIGS. 27 and 28, upright post 1710 is shown in profile having front support adjustment slot 1720 and rear support adjustment slot 1725. A circular section 2880 and 2890 may be used to further secure horizontal supports as they move along adjustment slots 1720 and 1725. Upright post 1710 is hollow to provide a lightweight and strong support structure. Of course the posts may be substantially solid with central slot 1750 to provide a space to fit the sign frame within. The posts and supports may be made of wood, plastic, aluminum, or other suitable metal or composite. The slip over decorative frame may be painted or left with a natural finish for particular applications. Additionally, the finials tops may be removed altogether or replaced with other items such as a simple cap or flag holder depending on the application.

Although the instant invention has been described in relation to particular embodiments thereof, many other variations and modifications and other uses will become apparent to those skilled in the art.

What is claimed is:

1. A slip over decorative frame comprises:
a first upright post;
a second upright post;
an upper horizontal support disposed along an upper portion of said first and second upright post;
at least one lower horizontal support disposed along a lower portion of said first and second upright post and below said upper horizontal support; and
said first and second upright posts having a slot centrally disposed therein wherein a sign frame fits therein.

2. A slip over decorative frame according to claim 1 further comprising a finial disposed on a top portion of each first and second upright post.

3. A slip over decorative frame according to claim 1 further comprising at least one security hole disposed in a portion of said at least one lower horizontal support wherein said sign is removeably secured therein.

4. A slip over decorative frame according to claim 1 further comprising an upper sign slot disposed on a top edge of said upper horizontal support wherein an additional sign is removeably insertable therein.

5. A slip over decorative frame according to claim 1 wherein said sign frame includes a sign.

6. A slip over decorative frame according to claim 5 wherein said sign includes a sign panel.

7. A slip over decorative frame according to claim 1 wherein said first and second upright posts are substantially hollow.

8. A slip over decorative frame according to claim 2 further comprising a sign slot disposed in said finial wherein a sign is removeably insertable therein.

9. A slip over decorative frame according to claim 1 wherein said at least one lower horizontal support comprises a forward horizontal support and a rear horizontal support.

10. A slip over decorative frame according to claim 1 further comprising a sign slot disposed along a top portion of said upper horizontal support wherein said sign fits therein.

11. A slip over decorative frame according to claim 1 further comprising a sign separator disposed between said additional sign and an other additional sign.

12. A slip over decorative frame comprising:
a first frame;
a second frame;
said first and second frames having a slot on opposing facing surfaces wherein a sign fits therein;
an attachment means for securing said sign within said first and second frame.

13. A slip over decorative frame according to claim 12 wherein said attachment means comprises at least one hinge disposed on an edge of said first and second frames wherein said first and second frames moveably close and open to secure and conceal said sign.

14. A slip over decorative frame according to claim 12 further comprising a catch to selectively secure said first and second frames together.

15. A slip over decorative frame according to claim 12 further comprising a plurality of catching means to selectively secure said first and second frames together.

16. A slip over decorative frame according to claim 15 wherein said plurality of catching means are snaps.

17. A slip over decorative frame according to claim 15 wherein said plurality of catching means are cam fasteners.

18. A slip over decorative frame comprising:
a first and second upright post;
said first and second upright posts each having at least one adjustment slot running substantially along opposing facing sides;
an upper horizontal support having an insertion end opposedly disposed on each end therein;
at least one lower horizontal support having an insertion end opposedly disposed on each end therein;
a slot generally centrally disposed within said first and second vertical posts wherein a sign frame removeably fits therein; and
said upper and at least one lower horizontal support being adapted to moveably fit within said at least one adjustment slot wherein said upper and said at least one lower horizontal supports are independently adjustable to fit over and conceal a sign edge.

19. A slip over decorative frame according to claim 18 wherein said at least one adjustment slot comprises two parallely disposed adjustment slots wherein each of said forward and rear horizontal supports are independently adjustable along said adjustment slots.

20. A slip over decorative frame according to claim 18 further comprising at least one insertion opening disposed on said at least one adjustment slot wherein said insertion end is inserted therein.
